(19) United States
(12) Patent Application Publication
(10) Pub. No.: US 2009/0216677 A1
(43) Pub. Date: Aug. 27, 2009

(54) System and Method for Virtual Capital Operation

(75) Inventors: Shin-Hsien Kuo, Taipei (TW); Tsung-Hsun Tsai, Taipei (TW); Ying-Teng Chen, Taipei (TW); Jen-Shun Yang, Taoyuan (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Industrial Technology Research Institute

(21) Appl. No.: 12/406,582

(22) Filed: Mar. 18, 2009

Related U.S. Application Data
(62) Division of application No. 11/227,653, filed on Sep. 15, 2005.

(51) Int. Cl. G06Q 40/00

(52) U.S. Cl. 705/44

(57) ABSTRACT

A system for virtual capital operation over a network such as the internet includes a platform for a transaction between a first user and a second user of the system, a data processor for processing the flow of virtual currency occurred at the transaction between the first user and second user, and a trust company to allow real currency to be stored therein or withdrew therefrom in response to the flow of real currency occurred at the transaction, wherein the data processor generates an amount of virtual currency in response to an amount of real currency entrusted to the trust company.

### CROSS REFERENCE TO RELATED APPLICATIONS

This application is a divisional application of application Ser. No. 11/227,653, filed Sep. 15, 2005, incorporated herein by reference in its entirety, and claims the benefit of its earlier filing date.

### BACKGROUND OF THE INVENTION

The present invention generally relates to e-commerce and, more particularly, to a system and method for virtual capital operation on the internet.

Current virtual money, which may be paid through credit cards or debit cards, is simply a substitutional monetary instrument for real currencies during transactions. Some of the virtual money provides a monetary return while purchasing goods through currencies. The monetary return, which may include bonus points or cash feedback, usually has the following restrictions: (1) The bonus points collected at a time of purchase are available for use only in future purchases before they are expired; and (2) The bonus points collected at a time of purchase are cashable at the time of the purchase or in future purchases through a cash rebate. Such kinds of monetary return are therefore not user-friendly.

An example of the current virtual money is that popularly used in internet games. Players of the games must purchase the virtual money from a game provider before they join the games. From the view point of the players, only a one-way exchange between real currency and virtual money is available because the game provider usually does not allow the players to exchange virtual money for real currency. The players may sell their virtual money collected over time to other players of the games for real currency. However, such virtual money often suffers from depreciation or even becomes obsolete if the games are no longer popular or the game provider has become financially embarrassed. Furthermore, circulation of the virtual money may be limited because it is not usually acceptable from game to game.

Another example of the current virtual money is prepaid cards or value-added cards. Users of such cards must previously pay real currency for corresponding points or value from a card company. The points or value are stored in a card, and may be decreased as a result of the card owner's purchase activities, or increased by a further purchase of points or value. Such pre-paid cards or value-added cards, likewise, are only one-way exchangeable because the card releasing company usually does not allow users to exchange the remaining points or value in a card for real currency.

It is desirable to have a system or method that provides a flexible exchange between virtual money and real currency. It is also desirable to have a system or method that ensures the security of exchange between virtual money and real currency through a reliable third party such as a trust company. Furthermore, the system or method is expected to create a snowball effect during transactions, in which one transaction may trigger more subsequent transactions through the operation of virtual capital accumulated from the transactions.

### BRIEF SUMMARY OF THE INVENTION

The present invention is directed to a system and method for virtual capital operation over a network such as the internet that obviates one or more problems resulting from the limitations and disadvantages of the prior art.

In accordance with an embodiment of the present invention, there is provided a system for virtual capital operation over a network such as the internet that comprises a platform for a transaction between a first user and a second user of the system, a data processor for processing the flow of virtual currency occurred at the transaction between the first user and second user, and a trust company to allow real currency to be stored therein or withdrawn therefrom in response to the flow of real currency occurred at the transaction, wherein the data processor generates an amount of virtual currency in response to an amount of real currency entrusted to the trust company.

Also in accordance with the present invention, there is provided a system for virtual capital operation over a network such as the internet that comprises a platform for a transaction between a first user and a second user of the system, a data processor for processing the flow of virtual currency occurred at the transaction between the first user and second user, and a trust company to allow real currency to be stored therein or withdrawn therefrom in response to the flow of real currency occurred at the transaction, wherein the data processor calculates the gross profit collected from the transaction, and provides an amount of virtual currency equivalent to the amount of gross profit.

Further in accordance with the present invention, there is provided a method for virtual capital operation over a network such as the internet that comprises providing a platform for a transaction between a first user and a second user, calculating the gross profit collected from the transaction, determining whether the gross profit includes real currency, entrusting the amount of real currency to a trust company if the gross profit includes real currency, and generating an amount of virtual currency equivalent to the amount of real currency entrusted.

Still in accordance with the present invention, there is provided a method for virtual capital operation over a network such as the internet that comprises providing a platform for a transaction between a first user and a second user, calculating the gross profit collected from the transaction, the gross profit including real currency and virtual currency, entrusting the amount of real currency to a trust company, generating an amount of virtual currency equivalent to the amount of real currency entrusted, calculating a total amount of virtual currency by adding the virtual currency in the gross profit and the virtual currency generated in response to the real currency entrusted, and distributing a part of the total amount of virtual currency to the first user.

Yet still in accordance with the present invention, there is provided a method for virtual capital operation over a network such as the internet that comprises providing a platform for a transaction between a first user and a second user, calculating the gross profit collected from the transaction, providing an amount of virtual currency equivalent to the amount of the gross profit, and distributing a part of the amount of virtual currency to the first user.

Further in accordance with the present invention, there is provided a method for virtual capital operation over a network such as the internet that comprises providing a platform for a transaction between a user of a system and a system operator, the system operator issuing virtual currency for circulation within the system, determining whether the user requests a loan from the system operator at the platform, determining whether the amount of the loan exceeds an acceptable level, and providing an amount of virtual currency to the user equivalent to the amount of the loan minus a service fee if the amount of the loan does not exceed the acceptable level.

Still in accordance with the present invention, there is provided a method for virtual capital operation over a network such as the internet that comprises providing a platform for a transaction between a user of a system and a system operator, the system operator issuing virtual currency for circulation within the system, determining whether the user requests a loan from the system operator at the platform, providing an amount of virtual currency to the user equivalent to the amount of the loan minus a service fee, determining whether the user repays the loan by paying an amount of currency equivalent to the loan plus an interest, determining whether the amount of currency includes real currency for the interest, entrusting the real currency for the interest to a trust company, and generating an amount of virtual currency equivalent to the real currency entrusted.

Yet still in accordance with the present invention, there is provided a method for virtual capital operation over a network such as the internet that comprises providing a platform for a transaction between a user of a system and a system operator, the system operator issuing virtual currency for circulation within the system, determining whether the user requests an exchange between real currency and virtual currency, entrusting an amount of real currency to a trust company if the user exchanges real currency for virtual currency, and generating an amount of virtual currency for the user, and withdrawing an amount of real currency from a trust company if the users exchanges virtual currency for real currency, and providing the amount of real currency to the user.

### BRIEF DESCRIPTION OF THE SEVERAL VIEWS OF THE DRAWINGS

The foregoing summary as well as the following detailed description of the preferred embodiments of the present invention will be better understood when read in conjunction with the appended drawings. For the purposes of illustrating the invention, there are shown in the drawings embodiments which are presently preferred. It is understood, however, that the invention is not limited to the precise arrangements and instrumentalities shown. In the drawings:

FIG. 1 is a schematic diagram of a system for virtual capital operation in accordance with one embodiment of the present invention;

FIG. 2 is a schematic diagram illustrating a method for virtual capital operation in accordance with one embodiment of the present invention;

FIG. 3 is a schematic diagram illustrating a method for virtual capital operation in accordance with another embodiment of the present invention;

FIG. 4 is a schematic diagram illustrating a method for virtual capital operation in accordance with still another embodiment of the present invention;

FIG. 5 is a flow diagram of a method for virtual capital operation in accordance with one embodiment of the present invention;

FIG. 6A is a schematic diagram illustrating a method for requesting a loan in accordance with one embodiment of the present invention;

FIG. 6B is a flow diagram of the method illustrated in FIG. 6A;

FIG. 7A is a schematic diagram illustrating a method for repaying a loan in accordance with one embodiment of the present invention;

FIG. 7B is a schematic diagram illustrating a method for repaying a loan in accordance with another embodiment of the present invention;

FIG. 8 is a flow diagram of a method for repaying a loan in accordance with one embodiment of the present invention;

FIG. 9A is a schematic diagram illustrating a method for currency exchange in accordance with one embodiment of the present invention; and

FIG. 9B is a schematic diagram illustrating a method for currency exchange in accordance with another embodiment of the present invention.

### DETAILED DESCRIPTION OF THE INVENTION

The present invention provides a system and method of virtual capital operation that allows a customer to collect monetary feedback in the form of virtual capital through purchasing products, consuming services, and brokering or promoting products or services. According to the present invention, virtual capital may be accumulated without any limitations on maximum value and expiration date. Furthermore, the virtual capital may be exchanged for real currency or vice versa through a third-party trust company in order to ensure financial security. Customers and product/service providers therefore do not run the risk that the accumulated virtual capital is not exchangeable. The system and method according to the present invention are both applicable to e-commerce (“EC”) platforms and physical business stores.

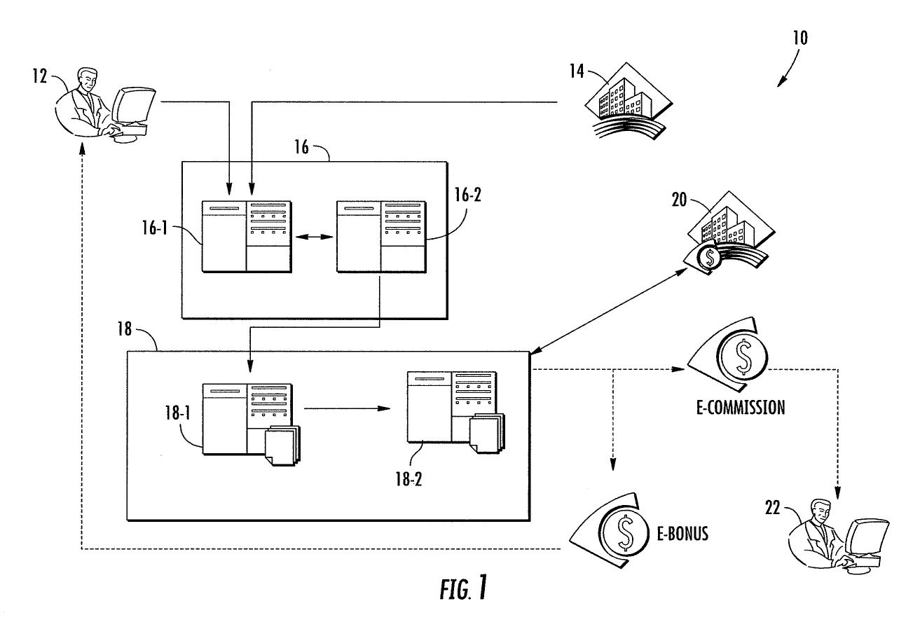

FIG. 1 is a schematic diagram of a system 10 for virtual capital operation in accordance with one embodiment of the present invention. The virtual capital or virtual currency, in contrast to real currency issued by a government, refers to a currency issued by an operator of a system to circulate in the system. The virtual capital operation refers to the use of virtual capital in a business operation over the interne or electronic communications networks. Referring to FIG. 1, system 10 includes at least one customer 12, at least one product/service provider 14, a transaction platform 16, a data processor 18 and a trust company 20. Customer 12 includes and is not limited to one who purchases products or consumes services in system 10, including an individual, a company or institution or the like. Provider 14 includes but is not limited to one who provides products or services for sale in system 10, including an individual, a company or institution or the like. Transaction platform 16 refers to one where a transaction between a customer 12 and a provider 14 takes place. Transaction platform 16 further includes a service platform 16-1 and a capital flow platform 16-2. Service platform 16-1, for example, a website accessible by a computer or a cellular phone, functions to serve as an interface for a product/service transaction between a user such as a customer 12 or a provider 14 and merchandise or a service. Capital flow platform 16-2, for example, an automated teller machine (“ATM”) or a website, functions to serve as an interface for a financial transaction between a user and a financial company such as a bank. Specifically, on one hand customer 12 purchases a product or service through service platform 16-1, and pays an equivalent amount of real currency or virtual currency or both through capital flow platform 16-2. On the other hand, provider 14 exhibits products or services on service platform 16-1, and receives virtual or real currency from capital flow platform 16-2. Since the capital flow generated by customer 12 and provider 14 involves at least one first financial unit (not shown), for example, a bank, at least one of customer 12 or provider 14 has an account in the first financial unit.

In one embodiment according to the present invention, users of system 10 such as customer 12 and provider 14 are required to register in system 10 at the first time when they use system 10. Transaction platform 16 verifies whether a user has registered in system 10, and does not provide service to a user until he or she is registered and has an identity assigned by system 10.

Data processor 18 keeps track of capital flow due to transactions which have occurred in transaction platform 16. Data processor 18 further includes a first sub-processor 18-1 and a second sub-processor 18-2. First sub-processor 18-1, for example, a database of the first financial unit, stores the capital flow information regarding a transaction between customer 12 and provider 14 under a corresponding account. Second sub-processor 18-2, for example, a database of an operator of system 10 (system operator), stores the capital flow information regarding the transaction under a corresponding identity. First sub-processor 18-1 may periodically check with second sub-processor 18-2, or vice versa, to determine whether the capital flow information is correct.

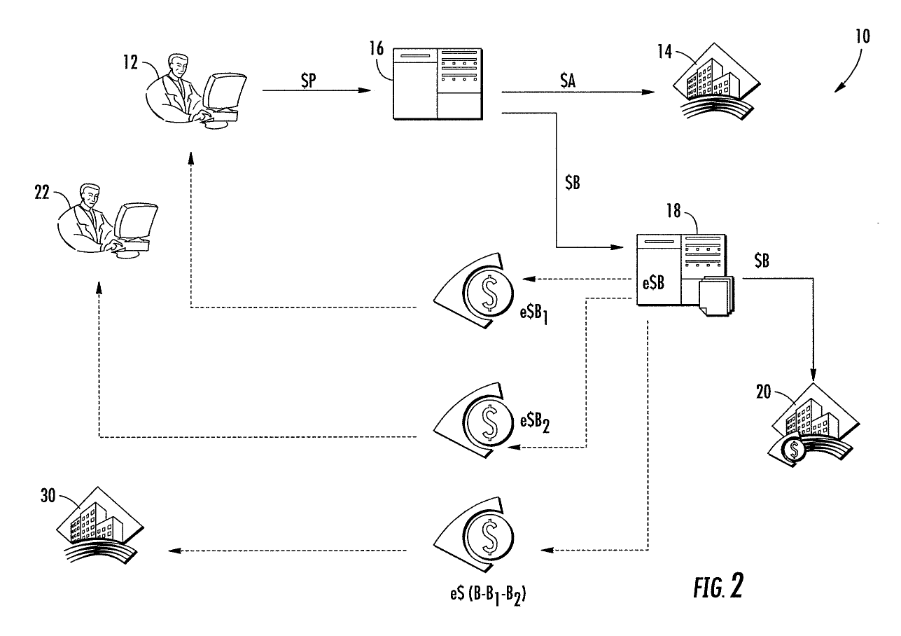

The currency paid by customer 12 at a transaction may include real currency, virtual currency or both. A part of the currency paid by customer 12 becomes a revenue of provider 14, while the other part of the currency becomes the system operator's gross profit. As a result, the system operator's gross profit may include real or virtual currency or both. The real currency in the gross profit is subsequently entrusted to a second financial unit, i.e., trust company 20. For each unit of real currency entrusted to trust company 20, an equivalent amount of virtual currency is generated in database 18 in accordance with an exchange ratio. The exchange ratio between real currency and virtual currency in system 10 is predetermined. For example, if the exchange ratio is one, one unit of virtual currency is worth one unit of real currency, or vice versa. The total virtual currency, including the virtual currency generated in database 18 due to the real currency and, if any, the virtual currency paid by customer 12 during the transaction, is divided into parts. A first part of the total virtual currency, which is called bonus, is distributed to customer 12 under the identity of customer 12. A second part of the total virtual currency, which is called commission, is distributed to a broker 22, if any, under the identity of broker 22. A broker, also a user of system 10 having an identity, refers to one who facilitates the purchase activities of customers or promotes the sale of products or services for providers. The remaining part of the virtual currency becomes the net profit of the system operator. The method for virtual capital operation will be described in detail by reference to FIGS. 2, 3 and 4 below. Throughout the specification, capital flow in real currency is illustrated in solid lines, while capital flow in virtual currency is illustrated in broken lines.

FIG. 2 is a schematic diagram illustrating a method for virtual capital operation in accordance with one embodiment of the present invention. Referring to FIG. 2, customer 12 pays for products or services at transaction platform 16 in real currency alone. The real currency, denoted as $P, includes a first part $A, representing the revenue of provider 14 collected at the current transaction, and a second part $B, representing the gross profit of the system operator. Data processor 18 stores the capital flow information occurred at the transaction. For example, an amount of real currency $A entitled to provider 14 is stored under the identity of provider 14. The system operator, having opened an account in trust company 20, entrusts the amount of real currency $B to trust company 20 under the account. Simultaneously, data processor 18 generates an amount of virtual currency, e$B, equivalent in value to the entrusted real currency $B. A first part of the virtual currency e$B, denoted as e$B₁, is distributed to customer 12 to encourage further purchases. In response to the distribution, data processor 18 stores the virtual currency e$B₁ under the identity of customer 12. A second part of the virtual currency e$B, denoted as e$B₂, is distributed to broker 22, if any. Likewise, data processor 18 stores the virtual currency e$B₂ under the identity of broker 22. The identity of broker 22 may be specified by customer 12 or provider 14 during the transaction. The remaining of the virtual currency e$B, that is, e$ (B−B₁−B₂), is retained as the net profit of the system operator. In this way, the system operator accumulates virtual capital as transactions take place.

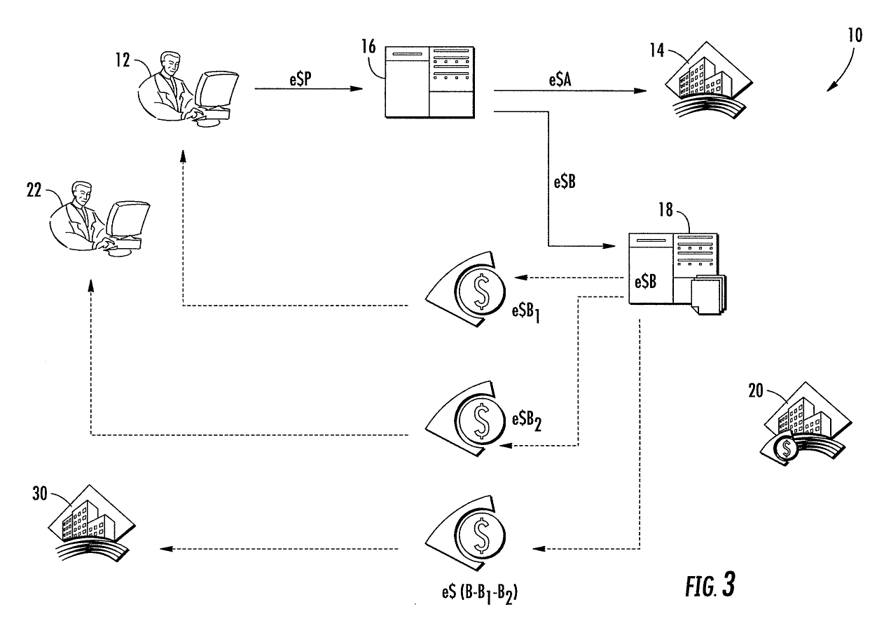

FIG. 3 is a schematic diagram illustrating a method of virtual capital operation in accordance with another embodiment of the present invention. The method illustrated in FIG. 3 is similar to that illustrated in FIG. 2 except that customer 12 pays in virtual currency instead of real currency. Referring to FIG. 3, the virtual currency, denoted as e$P, includes a first part e$A, representing the revenue of provider 14 collected at the current transaction, and a second part e$B, representing the gross profit of the system operator. Data processor 18 stores the capital flow information occurred at this transaction. For example, an amount of virtual currency e$A entitled to provider 14 is stored under the identity of provider 14. Since a real-world trust company does not accept the virtual currency, trust company 20 is idle for the transaction. Data processor 18 distributes a first part of the virtual currency e$B, denoted as e$B₁, to customer 12, and stores the virtual currency e$Bᵢ under the identity of customer 12. Data processor 18 distributes a second part of the virtual currency e$B, denoted as e$B₂, to broker 22, if any, and stores the virtual currency e$B₂ under the identity of broker 22. The remaining of the virtual currency e$B, that is, e$ (B−B₁−B₂), is retained as the net profit of the system operator.

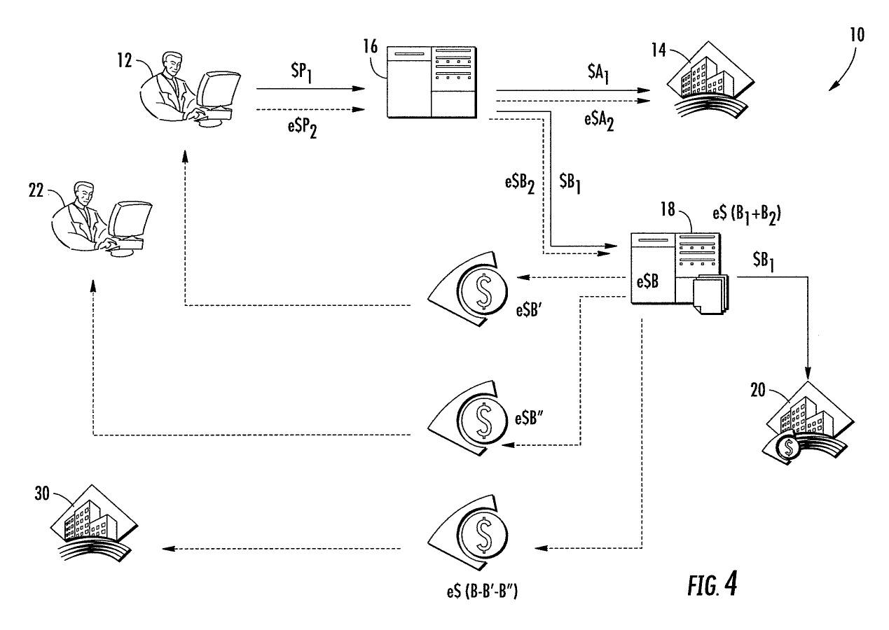

FIG. 4 is a schematic diagram illustrating a method for virtual capital operation in accordance with still another embodiment of the present invention. Referring to FIG. 4, customer 12 pays for products or services at transaction platform 16 partly by real currency and partly by virtual currency. The real currency $P₁ includes a first part $A₁ and a second part $B₁, and the virtual currency e$P₂ includes a first part e$A₂ and a second part e$B₂. The revenue of provider 14 collected at the current transaction is $A₁ and e$A₂. The gross profit of the system operator is $B₁ and e$B₂. Data processor 18 stores the capital flow information occurred at the transaction. For example, an amount of real currency $A₁ and an amount of virtual currency e$A₂ entitled to provider 14 are stored under the identity of provider 14. The system operator entrusts the amount of real currency $B₁ to trust company 20. The gross profit in the form of virtual capital stored in data processor 18 is e$ (B₁+B₂), where e$B₁ is received from transaction platform 16 and e$B₂ is generated in response to the real currency $B₁ entrusted. A first part of the total virtual currency e$B, denoted as e$B′, is distributed to customer 12 and stored under the identity of customer 12. A second part of the virtual currency e$B, denoted as e$B″, is distributed to broker 22, if any, and stored under the identity of broker 22. The remaining of the virtual currency e$B, that is, e$ (B−B′−B″), is retained as the net profit of the system operator.

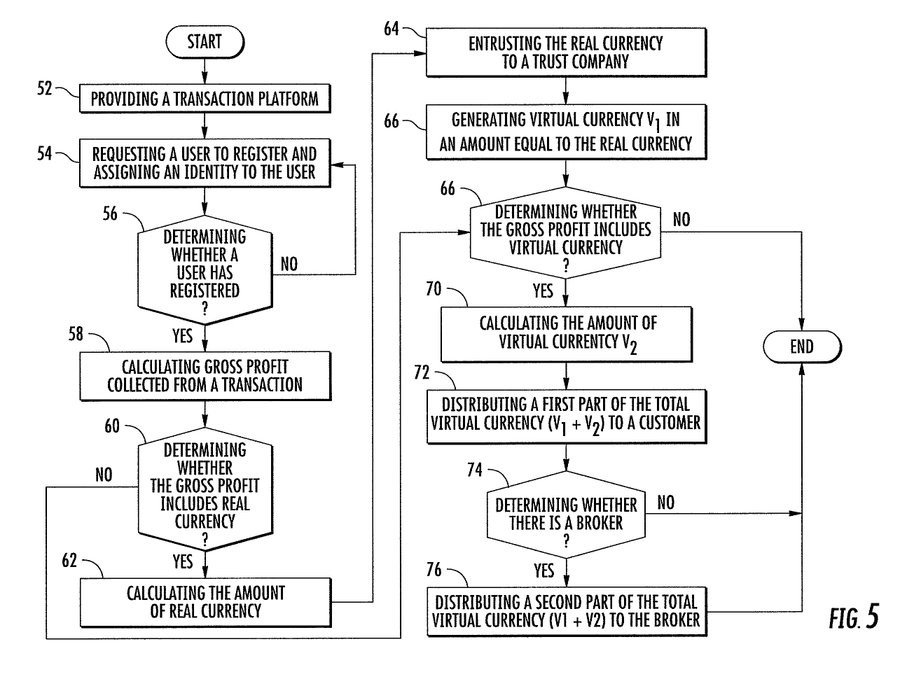

FIG. 5 is a flow diagram of a method for virtual capital operation in accordance with one embodiment of the present invention. Referring to FIG. 5, also by reference to FIGS. 2 to 4, a transaction platform 16 is provided at step 52 to facilitate transactions between customer 12 and provider 14. A user, including customer 12, provider 14 and broker 22, is requested to register at step 54 so as to obtain an identity in system 10 assigned by the system operator. At step 56, system 10 determines whether a user has registered and does not provide service to a user until he or she has an identity. Next, at step 58, whenever a transaction takes place, the gross profit of the system operator collected at the transaction is calculated by, for example, data processor 18. The gross profit may include real currency, virtual currency or both, depending on the kind of currency paid by customer 12 at the transaction, which is determined at step 60. If the gross profit includes real currency, at step 62, the amount of the real currency is calculated and then, at step 64, entrusted to trust company 20. Next, at step 66, an amount of virtual currency V_{I} is generated in data processor 18 in response to the real currency entrusted. The exchange ratio between the real and virtual currencies is predetermined.

Next, at step 68, it is determined whether the gross profit includes virtual currency. In addition, the method jumps to step 68 if at step 60 it is determined that the gross profit does not include any real currency. If the gross profit includes virtual currency, at step 70, the amount of virtual currency V₂ is calculated. Next, at step 72, a first part of the total virtual currency V_{I}+V₂ is distributed to customer 12. The ratio between the first part and the total virtual currency is predetermined. At step 74, it is determined whether there is a broker 22 in the transaction. If confirmative, a second part of the total virtual currency is distributed to broker 22. The ratio between the second part and the total virtual currency is predetermined. The remaining part of the total virtual currency is retained as the net profit of the system operator.

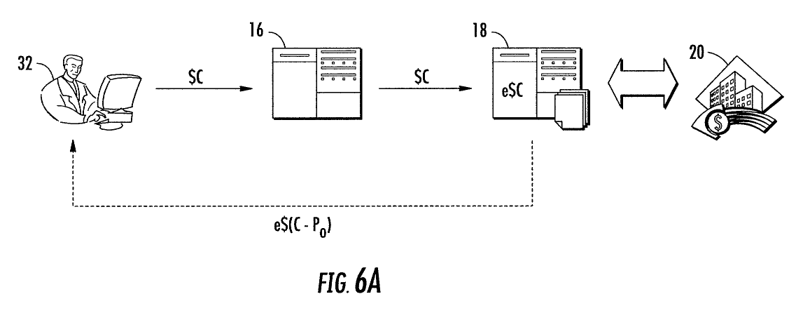

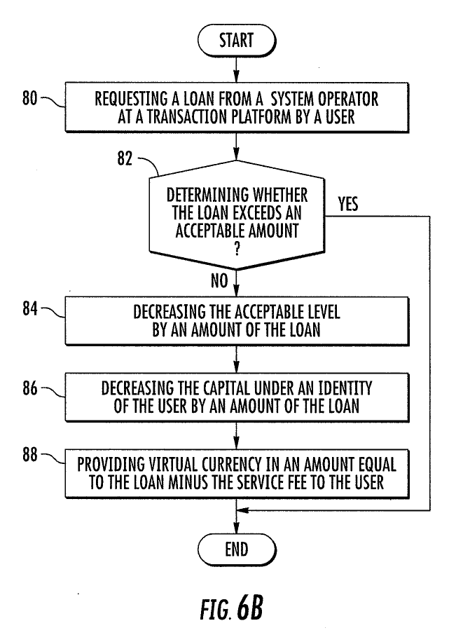

FIG. 6A is a schematic diagram illustrating a method for requesting a loan in accordance with one embodiment of the present invention. Referring to FIG. 6A, a user 32 requests a loan $C from the system operator at transaction platform 16. Data processor 18 acknowledges the request and checks with trust company 20 to determine whether the amount $C is acceptable. The request is declined, for example, if the amount $C exceeds a safety level, which is related to the amount of real currency stored in trust company under the system operator's account. If the request is accepted, data processor 18 provides an amount of virtual currency e$ (C−P₀) to user 32, where P₀ represents a service fee charged by the system operator. Meanwhile, data processor 18 lowers the safety level by $C.

FIG. 6B is a flow diagram of the method illustrated in FIG. 6A. Referring to FIG. 6B, at step 80, a loan request is made. At step 82, if the amount of loan exceeds an acceptable amount, the request is rejected. If the request is acceptable, at step 84, data processor 18 decreases the acceptable amount by the amount of the loan, i.e., to a lower level. Next, at step 86, the virtual capital level under the identity of user 32 is decreased by an amount of the loan. At step 88, data processor 18 provides to user 32 an amount of virtual currency equivalent to the loan minus a service fee.

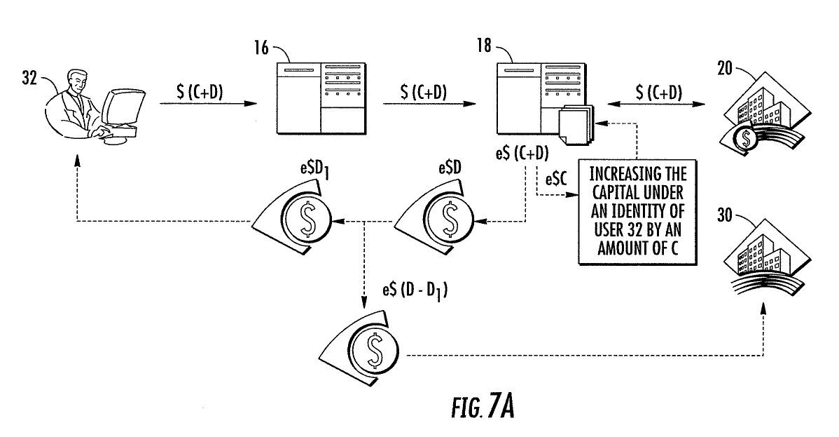

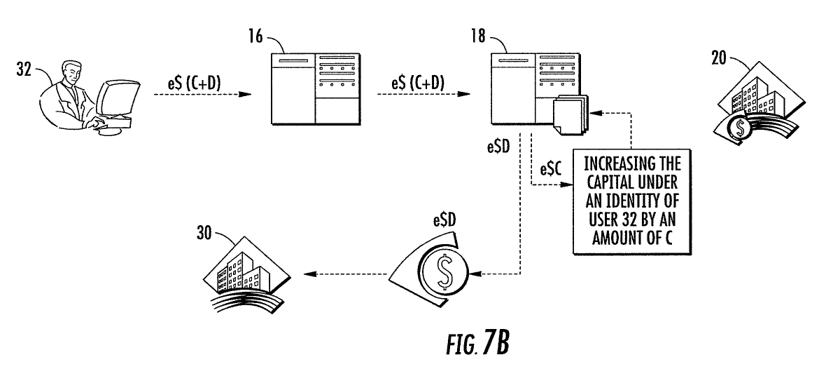

FIG. 7A is a schematic diagram illustrating a method for repaying a loan in accordance with one embodiment of the present invention. Referring to FIG. 7A, user 32 pays an amount of $(C+D) in real currency at transaction platform 16, where $C is the loan size, and $D is interest. Data processor 18 increases the capital level under the identity of user 32 by an amount of C, which writes off the loan. The real currency $ (C+D) is entrusted to trust company 20. Data processor 18 generates an amount of virtual currency equivalent to the real currency $D entrusted. A part of the generated virtual currency e$D, denoted as e$D_{I}, is distributed to user 32. The remaining part, i.e., e$ (D−Dᵢ), is retained as the system operator's virtual capital.

FIG. 7B is a schematic diagram illustrating a method for repaying a loan in accordance with another embodiment of the present invention. Referring to FIG. 7B, user 32 pays an amount of e$ (C+D) in virtual currency at transaction platform 16. Data processor 18 writes off the loan by increasing the amount of capital under the identity of user 32. The interest e$D is retained as the system operator's virtual capital.

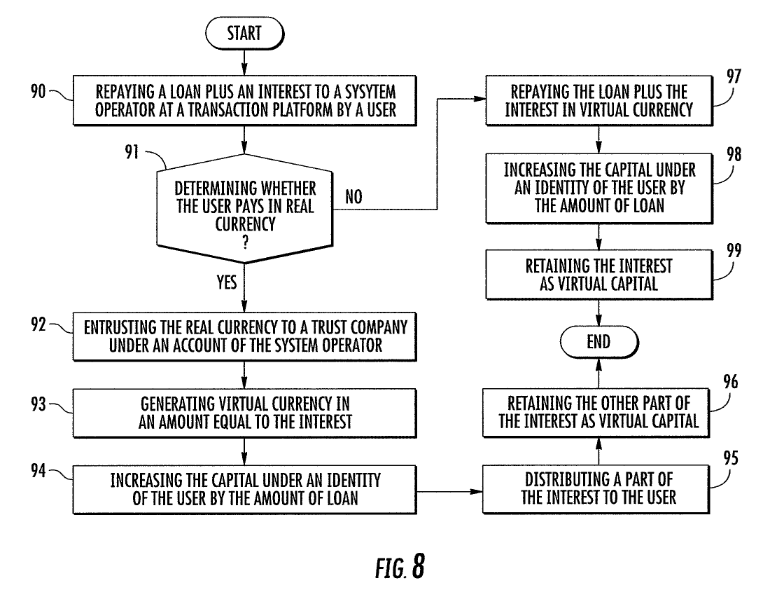

FIG. 8 is a flow diagram of a method for repaying a loan in accordance with one embodiment of the present invention. Referring to FIG. 8, also by reference to FIGS. 7A and 7B, user 32 repays a loan with interest to the system operator at transaction platform 16 at step 90. The currency paid by user 32 may include real currency or virtual currency, which is determined at step 91. The real currency, if any, is entrusted to trust company 20 at step 92. An amount of virtual currency equivalent to the interest part of the entrusted real currency is generated in data processor 18 at step 93. At step 94, data processor 18 writes off the loan. A part of the virtual currency generated is distributed to user 32 at step 95, and the remaining part is retained as the system operator's virtual capital at step 96. On the other hand, if at step 90 user 32 does not pay in real currency, it is determined at step 97 that virtual currency is paid. At step 98, data processor 18 writes off the loan. Next, at step 99, the interest part is retained as the system operator's virtual capital.

Skilled persons in the art will understand that the method illustrated in FIG. 8 is also applicable to the case when user 32 repays the loan part in real currency and part in virtual currency. The real currency is entrusted to trust company 20. An amount of virtual currency equivalent to a part of the interest that is paid in real currency is generated. As a result, the bonus distributed to user 32 is smaller than that in the example illustrated in FIG. 7A.

Skilled persons in the art will also understand that user 32 may repay only a part of the loan. In such a case, an amount of virtual currency equivalent to a part of the interest that is paid in real currency is generated.

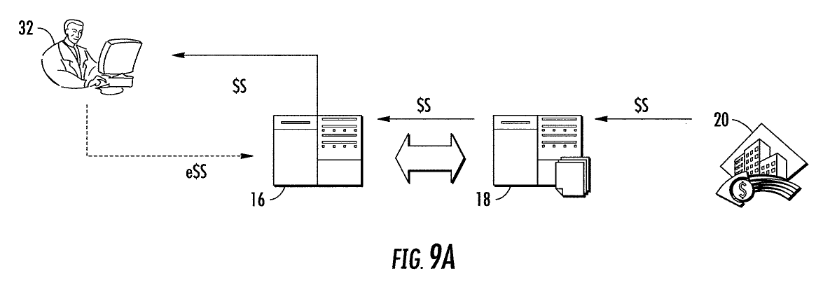

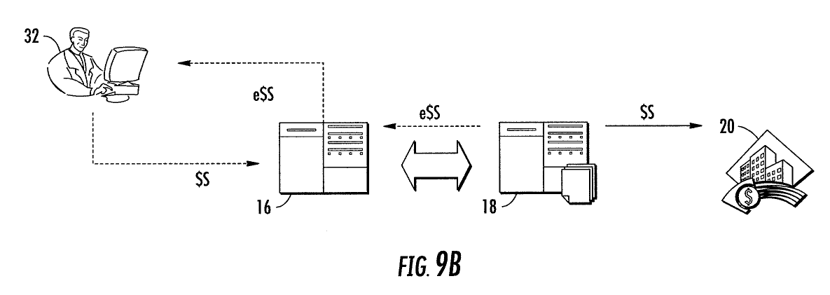

FIG. 9A is a schematic diagram illustrating a method for currency exchange in accordance with one embodiment of the present invention. Referring to FIG. 9A, user 32 requests to exchange virtual currency e$S for real currency $S at transaction platform 16. In response to the request, data processor 18 increases the system operator's capital by an amount of e$S and decreases the virtual capital under the identity of user 32 by the amount of e$S. Data processor 18 requests a withdrawal of $S from trust company 20 under the system operator's account. Transaction platform 16 then provides the real currency $S to user 32.

FIG. 9B is a schematic diagram illustrating a method for currency exchange in accordance with another embodiment of the present invention. Referring to FIG. 9B, user 32 requests to exchange real currency $S for virtual currency e$S at transaction platform 16. In response to the request, data processor 18 decreases the system operator's capital by an amount of e$S and increases the virtual capital under the identity of user 32 by the amount of e$S. User 32 is informed at transaction platform 16 of an amount of virtual currency e$S stored under his identity. The amount of real currency $S is entrusted to trust company 20 under the system operator's account.

A system operator of the present invention may create a snowball effect through the use of virtual capital, for example, by way of bonus, commission and loan. Specifically, the system operator provides a part of gross profit collected at a transaction as a monetary return to a customer who purchases a product or service through a broker, if any, who facilitates the transaction. The monetary return encourages further purchases from customers. The remaining part of the gross profit, i.e., the net profit, is accumulated as the system operator's virtual capital, which may be loaned to providers upon request. The monetary return and the loan attracts more customers and providers, which in turn may produce more transactions, which in turn create more accumulated virtual capital. Consequently, more and more potential customers and providers join the system, and in turn more and more virtual capital is accumulated, forming a positive feedback loop that reinforces the relationship between customers and providers, resulting in the so-called snowball effect.

It will be appreciated by those skilled in the art that changes could be made to the preferred embodiments described above without departing from the broad inventive concept thereof. It is understood, therefore, that this invention is not limited to the particular embodiments disclosed, but is intended to cover modifications within the spirit and scope of the present application as defined by the appended claims.

What is claimed is:

1. A method for virtual capital operation over a network such as the internet, comprising:
providing a platform for a transaction between a user of a system and a system operator, the system operator issuing virtual currency for circulation within the system;
determining whether the user requests a loan from the system operator at the platform; determining whether an amount of the loan exceeds an acceptable level; and
providing an amount of virtual currency to the user equivalent to the amount of the loan in response to the amount of the loan not exceeding the acceptable level.

2. The method of claim 1, further comprising decreasing the acceptable level by the amount of the loan.

3. The method of claim 1, further comprising:
assigning an identity to the user; and
decreasing an amount of virtual currency stored under the identity of the user by the amount of the loan.

4. The method of claim 1, further comprising retaining the amount of the service fee as an amount of virtual capital of the system operator.

5. An apparatus comprising a processor, the processor configured to:
perform a transaction between a user and a system operator, the system operator issuing virtual currency for circulation;
determine whether the user requests a loan from the system operator;
determine whether an amount of the loan exceeds an acceptable level; and
provide an amount of virtual currency to the user equivalent to the amount of the loan in response to the amount of the loan not exceeding the acceptable level.

6. The apparatus of claim 5, wherein the processor is further configured to decrease the acceptable level by the amount of the loan.

7. The apparatus of claim 5, wherein the processor is further configured to:
assign an identity to the user; and
decrease an amount of virtual currency stored under the identity of the user by the amount of the loan.

8. The apparatus of claim 5, wherein the processor is further configured to retain the amount of the service fee as an amount of virtual capital of the system operator.
